(19) United States
(12) Patent Application Publication
(10) Pub. No.: US 2014/0287302 A1
(43) Pub. Date: Sep. 25, 2014

(54) ANODE ACTIVE MATERIAL FOR SODIUM BATTERY, ANODE, AND SODIUM BATTERY

(71) Applicant: SUMITOMO ELECTRIC INDUSTRIES, LTD., Osaka-shi, Osaka (JP)

(72) Inventors: Atsushi Fukunaga, Osaka-shi (JP); Shinji Inazawa, Osaka-shi (JP); Koji Nitta, Osaka-shi (JP); Shoichiro Sakai, Osaka-shi (JP)

(73) Assignee: Sumitomo Electric Industries, Ltd., Osaka-shi, Osaka (JP)

(21) Appl. No.: 14/356,527

(22) PCT Filed: Nov. 5, 2012
(86) PCT No.: PCT/JP2012/078590

§ 371 Date: May 6, 2014

(30) Foreign Application Priority Data
Nov. 10, 2011 (JP) 2011-246110

(51) Int. Cl. H01M 4/485

(52) U.S. Cl. CPC H01M 4/485
USPC 429/188; 429/231.1; 423/598; 252/182.1

(57) ABSTRACT

Sodium titanium oxide is used as an anode active material for a sodium battery to improve the cycle properties of the sodium battery. For example, the anode active material is preferably a sodium titanium oxide having the following composition formula (1) or (2). Na_{2+X}Ti₃O₇ (0≦X≦0.9) Composition formula (1) Na_{4+X}Ti₅O₁₂ (0≦X≦1.0) Composition formula (2) The sodium titanium oxide may have the following composition formula by reducing the water content of the battery and optimizing the particle size of the active material. Na_{2+X}Ti₃O₇ (0≦X≦2.0) Composition formula (1′) Na_{4+X}Ti₅O₁₂ (0≦X≦2.0) Composition formula (2′)

### TECHNICAL FIELD

The present invention relates to an anode active material for a sodium battery, an anode, and a sodium battery.

### BACKGROUND ART

In recent years, natural energy, such as sunlight or wind power, has been actively utilized for the generation of electricity. The generation of electricity utilizing natural energy greatly depends on the climate and weather, and the electrical power output cannot be adjusted to the electric power demand. Thus, load leveling is indispensable in the generation of electricity utilizing natural energy. Load leveling involves the storage and release of electrical energy, for example, using high-energy-density high-efficiency secondary batteries.

One known high-energy-density high-efficiency secondary battery is a sodium-sulfur (NAS) battery. For example, Patent Literature 1 discloses a NAS battery that includes molten metallic sodium as an anode active material, molten sulfur as a cathode active material, and 13-alumina solid electrolyte disposed between the molten metallic sodium and the molten sulfur. The 13-alumina solid electrolyte can selectively transfer sodium ions.

### CITATION LIST

### Patent Literature

PTL 1: Japanese Unexamined Patent Application Publication No. 2007-273297

### SUMMARY OF INVENTION

### Technical Problem

In known sodium batteries, metallic Na, Sn, and Zn are used as anode active materials. Use of metallic Na, however, entails a risk of burning in the case where batteries malfunction. Sn and Zn may form an alloy with Na in an electrolyte solution and thereby causes a large volume change. Thus, repeated use of batteries results in the detachment of Sn and Zn from the electrode and poor cycle properties.

In view of these problems, it is an object of the present invention to provide an anode active material that can improve the cycle properties of a sodium battery.

### Solution to Problem

As a result of extensive studies to solve the problems described above, the present inventors completed the present invention by finding that sodium titanium oxide can be effectively used as an anode active material for a sodium battery. The present invention has the following features.

[1] An anode active material for a sodium battery, containing sodium titanium oxide.

[2] The sodium titanium oxide has the following composition formula (1) or (2), for example.

Na_{2+X}Ti₃O₇ (0≦X≦0.9) Composition formula (1)

Na_{4+X}Ti₅O₁₂ (0≦X≦1.0) Composition formula (2)

[3] The sodium titanium oxide in [1] may have the following composition formula by reducing the water content of the battery or optimizing the particle size of the active material.

Na_{2+X}Ti₃O₇ (0≦X≦2.0) Composition formula (1′)

Na_{4+X}Ti₅O₁₂ (0≦X≦2.0) Composition formula (2′)

[4] The anode active material according to [1], [2], or [3], wherein the sodium titanium oxide has an average particle size d₅₀ of 10 μm or less and a maximum particle size dₘₐₓ of 30 μm or less.

[5] An anode for a sodium battery, containing the anode active material according to any one of [1] to [4].

[6] The anode for a sodium battery according to [5], wherein the anode has a water content of less than 100 ppm.

[7] A sodium battery, including: a cathode; an anode; a separator disposed between the cathode and the anode; and an electrolyte containing sodium, the anode being the anode according to [5] or [6].

[8] The sodium battery according to [7], wherein the electrolyte is a molten salt containing sodium.

[9] The sodium battery according to [7] or [8], wherein the electrolyte contains sodium bis(fluorosulfonyl)amide (NaFSA) and potassium bis(fluorosulfonyl)amide (KFSA).

[10] The sodium battery according to [7] or [8], wherein the electrolyte contains a sodium cation, an organic cation, and a sulfonyl amide anion selected from bis(fluorosulfonyl)amide (FSA) and bis(trifluoromethylsulfonyl)amide (TFSA).

[11] The sodium battery according to [10], wherein the organic cation is an N-methyl-N-propylpyrrolidinium cation.

[12] The sodium batteries according to [7] to [11], wherein a cathode active material is NaCrO₂.

### Advantageous Effects of Invention

The present invention can provide an anode active material for a sodium battery and an anode that can improve the cycle properties. A high-capacity sodium battery having satisfactory cycle properties can be provided using the anode active material for a sodium battery and the anode.

### BRIEF DESCRIPTION OF DRAWINGS

FIG. 1 is a graph of the charge-discharge properties of a sodium battery produced in Example 1.

FIG. 2 is a graph of the initial (second cycle) charge-discharge properties of a half cell described in Example H-1.

FIG. 3 is a graph of the initial (second cycle) charge-discharge properties of a half cell described in Example H-2.

FIG. 4 is a graph of the initial (second cycle) charge-discharge properties of a half cell described in Example H-3.

FIG. 5 is a graph of the initial (second cycle) charge-discharge properties of a half cell described in Comparative Example H-4.

FIG. 6 is a graph of the initial (second cycle) charge-discharge properties of a half cell described in Comparative Example H-5.

FIG. 7 is a graph of the initial (second cycle) charge-discharge properties of a half cell described in Comparative Example H-6.

### DESCRIPTION OF EMBODIMENTS

An anode active material according to the present invention is an anode active material for a sodium battery and contains sodium titanium oxide. The present inventors found that use of sodium titanium oxide as an anode active material for a sodium battery allows a portion of the crystalline structure of the sodium titanium oxide to intercalate and deintercalate sodium ions in an electrolyte solution, and the sodium titanium oxide has a small volume change due to the intercalation and deintercalation of sodium ions. Thus, use of sodium titanium oxide as an anode active material for a sodium battery can improve the cycle properties of the sodium battery.

Examples of sodium titanium oxide for use in the present invention include Na₁Ti₂O₄, Na₂Ti₆O₁₃, Na₂Ti₃O₇, and Na₄Ti₅O₁₂. Among these, Na₂Ti₃O₇ and Na₄Ti₅O₁₂ are preferred. Na₂Ti₃O₇ and Na₄Ti₅O₁₂ that have intercalated sodium ions contained in an electrolyte solution may have the following composition formula (1) or (2).

Na_{2+X}Ti₃O₇ (0≦X≦0.9) Composition formula (1)

Na_{4+X}Ti₅O₁₂ (0≦X≦1.0) Composition formula (2)

The sodium titanium oxide may have the following composition formula by reducing the water content of the battery and optimizing the particle size of the active material.

Na_{2+X}Ti₃O₇ (0≦X≦2.0) Composition formula (1′)

Na_{4+X}Ti₅O₁₂ (0≦X≦2.0) Composition formula (2′)

For the composition formula (1′) and (2′), the particle size and the water content preferably have the following values.

The sodium titanium oxide preferably has an average particle size d₅₀ of 10 μm or less and a maximum particle size dₘₐₓ of 30 μm or less. When the sodium titanium oxide has an average particle size d₅₀ of 10 μm or less and a maximum particle size dₘₐₓ of 30 μm or less, this advantageously results in a reduced sodium ion diffusion length in the solid phase.

The average particle size d₅₀ is preferably 10 μm or less, more preferably 5 μm or less. The maximum particle size dₘₐₓ is preferably 30 μm or less, more preferably 15 μm or less.

The anode preferably has a water content of less than 100 ppm.

An anode for a sodium battery according to the present invention contains an anode active material according to the present invention as an anode active material. This can provide an anode for a sodium battery having satisfactory cycle properties.

A sodium battery according to the present invention may be a sodium battery containing an organic electrolyte solution as an electrolyte or a sodium battery containing a molten salt as an electrolyte, provided that the sodium battery contains sodium ions in the electrolyte thereof In particular, a sodium battery containing a molten salt as an electrolyte is preferred because the sodium battery can avoid the risk of burning of metallic sodium in the case where the battery malfunctions.

The structure of a sodium battery according to the present invention will be more specifically described using a molten salt electrolyte solution battery as a sodium battery containing a molten salt as an electrolyte.

### (Anode)

The anode includes an anode active material on a current collector for the anode. The anode active material is an anode active material according to the present invention.

The current collector for the anode is not particularly limited and may be made of at least one of aluminum, copper, nickel, stainless steel, molybdenum, tungsten, platinum, gold, and alloys thereof The current collector for the anode may have any shape and may be of a plate-like (foil-like) shape or may be a porous body having a three-dimensional network structure.

Such an anode active material may be applied to the current collector for the anode by mixing a powder of the anode active material with a conductive assistant material and a binder to form a paste, applying the paste to the current collector for the anode, adjusting the thickness of the paste, and drying the paste.

Preferred examples of the conductive assistant material include carbon black, such as acetylene black (AB) and ketjen black (KB). The conductive assistant material content of the anode is preferably 40% by mass or less, more preferably in the range of 5% to 20% by mass. The conductive assistant material content within this range tends to result in the production of a high-energy-density battery having satisfactory charge-discharge cycle properties. The conductive assistant material is not essential and may be appropriately added in accordance with the electrical conductivity of the anode.

Preferred examples of the binder include poly(vinylidene fluoride) (PVdF), polytetrafluoroethylene (PTFE), and polyimide (PI). The binder content of the anode is preferably 40% by mass or less, more preferably in the range of 1% to 10% by mass. The binder content within this range tends to result in stronger bonding between the anode active material and the conductive assistant material and appropriate electrical conductivity of the anode.

### (Cathode)

The cathode includes a cathode active material on a current collector for the cathode.

The cathode active material can preferably reversibly intercalate and deintercalate sodium ions and is preferably sodium chromite (NaCrO₂), NaFeO₂, or NaNi_{0.5}Mn_{0.5}O₂. In particular, sodium chromite (NaCrO₂) has satisfactory discharging properties (such as discharge capacity or voltage flatness) and cycle life characteristics as a cathode active material.

The current collector for the cathode is preferably made of aluminum. The current collector for the cathode may have any shape and may be of a plate-like (foil-like) shape or may be a porous body having a three-dimensional network structure.

Such a cathode active material may be applied to the current collector for the cathode by mixing a powder of the cathode active material with conductive assistant material and a binder to form a paste, applying the paste to the current collector for the cathode, adjusting the thickness of the paste, and drying the paste.

As in the anode, preferred examples of the conductive assistant material include carbon black, such as acetylene black (AB) and ketjen black (KB). As in the anode, the conductive assistant material content of the cathode is preferably 40% by mass or less, more preferably in the range of 5% to 20% by mass. The conductive assistant material content within this range tends to result in the production of a high-energy-density battery having satisfactory charge-discharge cycle properties. The conductive assistant material is not essential and may be appropriately added in accordance with the electrical conductivity of the cathode.

As in the anode, the binder may preferably be poly(vinylidene fluoride) (PVdF) or polytetrafluoroethylene (PTFE). As in the anode, the binder content of the cathode is preferably 40% by mass or less, more preferably in the range of 1% to 10% by mass. The binder content within this range tends to result in stronger bonding between the cathode active material and the conductive assistant material and appropriate electrical conductivity of the cathode.

### (Electrolyte)

The molten salt in the electrolyte may be an inorganic salt or an organic salt that can melt at the operating temperature. The cation of the molten salt other than sodium (Na) may be one or more selected from alkaline metals, such as lithium (Li), potassium (K), rubidium (Rb), and cesium (Cs), and alkaline-earth metals, such as beryllium (Be), magnesium (Mg), calcium (Ca), strontium (Sr), and barium (Ba).

In order to decrease the melting point of the molten salt, it is preferable to use a mixture of at least two salts. For example, combined use of potassium bis(fluorosulfonyl)amide <K—N(SO₂F)₂; KFSA>and sodium bis(fluorosulfonyl)amide <Na—N(SO₂F)₂; NaFSA>can result in a battery operating temperature of 90° C. or less.

When the molten salt electrolyte contains a sodium cation and an organic cation, the operating temperature of the sodium battery can be further reduced.

More specifically, the organic cation may be at least one of quaternary ammonium ion, imidazolium ion, imidazolinium ion, pyridinium ion, pyrrolidinium ion, piperidinium ion, morpholinium ion, phosphonium ion, piperazinium ion, and sulfonium ion.

### (Separator)

The separator prevents the contact between the cathode and the anode and may be a glass nonwoven fabric or a resin porous body. The separator is impregnated with the molten salt.

### (Battery)

A laminate of the anode, the cathode, and the separator impregnated with the molten salt housed in a case can be used as a battery.

### EXAMPLES

Although the present invention will be further described in the following examples, the present invention is not limited to these examples.

### Example 1

### (Preparation of Anode)

An Al foil having a thickness of 20 μm and a diameter of 16 mm was used as a current collector for an anode. A sodium titanium oxide (Na₂Ti₃O₇) having an average particle size d₅₀ of 10 μm and a maximum particle size dₘₐₓ of 30 μm was used as an anode active material. Acetylene black was used as a conductive assistant material, and poly(vinylidene fluoride) was used as a binder.

Na₂Ti₃O₇, the acetylene black, and poly(vinylidene fluoride) were mixed at a ratio of 85%, 5%, and 10% by mass, respectively. N-methyl-2-pyrrolidone (NMP) was added dropwise to and mixed with the mixture to produce a paste. The paste was applied to the Al foil and was pressed so as to have a thickness of 50 μm. The paste was dried at 120° C. for 60 minutes to form an anode 1 (this reference numeral is provided for the sake of convenience and is not the reference numeral in the drawings. The same applies hereinafter.).

### (Production of Cathode)

An Al foil having a thickness of 20 μm and a diameter of 15 mm was used as a current collector for a cathode. Sodium chromate (NaCrO₂) having an average particle size d₅₀ of 10 μm and a maximum particle size dₘₐₓ of 30 μm was used as a cathode active material. Acetylene black was used as a conductive assistant material, and poly(vinylidene fluoride) was used as a binder.

NaCrO₂, the acetylene black, and poly(vinylidene fluoride) were mixed at a ratio of 85%, 5%, and 10% by mass, respectively. N-methyl-2-pyrrolidone (NMP) was added dropwise to and mixed with the mixture to produce a paste. The paste was applied to the Al foil and was pressed so as to have a thickness of 50 μm. The paste was dried at 120° C. for 60 minutes to form a cathode 1.

### (Electrolyte)

A NaFSA-KFSA molten salt (NaFSA: 56 mol %, KFSA: 44 mol %) containing sodium ions was used as an electrolyte. The molten salt had a melting point of 57° C. A glass separator (porous glass cloth) having a thickness of 200 μm was impregnated with the molten salt.

### (Production of Sodium Battery)

The anode, the cathode, and the separator impregnated with the molten salt disposed therebetween were housed in a coin-type battery case to produce a sodium battery 1.

### Example 2

An anode 2 and a sodium battery 2 were produced in the same manner as in Example 1 except that the Na₂Ti₃O₇ in the anode 1 was replaced by a sodium titanium oxide (Na₄Ti₅O₁₂) having an average particle size d₅₀ of 5 μm and a maximum particle size dₘₐₓ of 15 μm.

### Comparative Example 1

A sodium battery 3 was produced in the same manner as in Example 1 except that an anode 3 made of metallic Sn was used as an anode. The metallic Sn had a thickness of 5 μm and a diameter of 16 mm.

### —Evaluation of Battery—

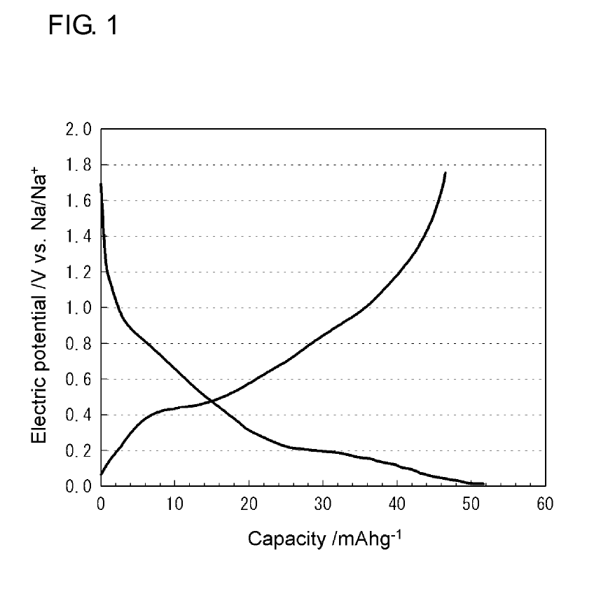

The sodium battery 1 under heating was subjected to a charge-discharge test at an operating temperature of 90° C., an initial charging voltage of 1.5 V, an initial discharge voltage of 3.5 V, and an electric current density of 0.6 mA/cm². FIG. 1 shows the results. The battery capacity was 0.9 mAh.

The charge-discharge cycle properties were examined to evaluate durability. The cycle properties serve as an important indicator for the cell life. 50 charge-discharge cycles were performed at an ambient temperature of 90° C. at a voltage in the range of 1.5 to 3.5 V at a constant current, and the discharge capacity was measured after 50 charge-discharge cycles. The discharge capacity after 50 charge-discharge cycles was compared with the initial capacity. Table I shows the results.

TABLE I

| | Discharge capacity [mAh] | | |
|---|---|---|---|
| | Initial | After 50 cycles | Rate of decrease |
| Example 1 | 0.9 | 0.89 | 1% |
| Example 2 | 0.9 | 0.87 | 3% |
| Comparative example 1 | 0.9 | 0.5 | 44% |

The results show that the sodium batteries according to the present invention had satisfactory cycle properties and improved life.

### (Evaluation of Half Cell)

A half cell described below was produced in order to evaluate the performance of the anode of the sodium battery 1. In order to evaluate the characteristics of the anode as a single electrode, the half cell included a sodium titanium oxide cathode and a metallic sodium anode to more precisely evaluate the electrode performance of the sodium titanium oxide.

### Example H-1

The specific structure of a half cell was described above with respect to the electrolyte and the separator. The cathode included an Al foil having a thickness of 20 μm and a diameter of 12 mm as a current collector for the cathode. A sodium titanium oxide (Na₂Ti₃O₇) having an average particle size d₅₀ of 10 μm and a maximum particle size dₘₐₓ of 30 μm was used as a cathode active material. Acetylene black was used as a conductive assistant material, and poly(vinylidene fluoride) was used as a binder. Na₂Ti₃O₇, the acetylene black, and poly(vinylidene fluoride) were mixed at a ratio of 85%, 5%, and 10% by mass, respectively. N-methyl-2-pyrrolidone (NMP) was added dropwise to and mixed with the mixture to produce a paste. The paste was applied to the Al foil and was pressed so as to have a thickness of 50 μm. The paste was dried at 120° C. for 60 minutes to form a cathode 1. The water content Q of the cathode 1 was Q<100 ppm.

The anode was a metallic sodium foil having a thickness of 200 μm and a diameter of 14 mm. This was referred to as a half cell 1.

The water content of the electrode was measured using a Karl Fischer method. The particle size was measured using a laser diffraction method.

### Example H-2

A cathode 2 and a half cell 2 were produced in the same manner as in Example H-1 except that sodium titanium oxide (Na₂Ti₃O₇) having an average particle size d₅₀ of 5 μm and a maximum particle size dₘₐₓ of 15 μm was used as a cathode active material in the cathode 1. The water content Q of the sodium titanium oxide electrode was Q<100 ppm (less than 100 ppm).

### Example H-3

A half cell 3 was produced in the same manner as in Example H-1 except that the NaFSA-KFSA molten salt electrolyte (NaFSA: 56 mol %, KFSA: 44 mol %) in Examples H-1 and H-2 was replaced by a molten salt electrolyte containing sodium and an organic cation.

In this case, a molten salt electrolyte containing the organic cation was N-methyl-N-propylpyrrolidinium bis(fluorosulfonyl)amide (hereinafter referred to as “P13FSA”). The P13FSA was mixed with sodium bis(fluorosulfonyl)amide (hereinafter referred to as “NaFSA”) at a P13FSA/NaFSA ratio (molar ratio) of 9/1 to produce a mixed molten salt electrolyte.

### Comparative Example H-4

A cathode 4 and a half cell 4 were produced in the same manner as in Example H-1 except that sodium titanium oxide (Na₂Ti₃O₇) having a relatively large particle size, that is, an average particle size d₅₀ of 30 μm and a maximum particle size dₘₐₓ of 80 μm was used as a cathode active material in the cathode 1. The water content Q of the sodium titanium oxide electrode was Q<100 ppm.

### Comparative Example H-5

A cathode 5 and a half cell 5 were produced in the same manner as in Example H-1 except that the sodium titanium oxide electrode in the cathode 1 had a high water content Q of about 1000 ppm.

### Comparative Example H-6

A cathode 6 and a half cell 6 were produced in the same manner as the cathode 5 and the half cell 5 according to Comparative Example H-5 except that the water content was increased to 7.2%.

Table II summarizes Examples H-1 to H-3 and Comparative Examples H-4 to H-6.

TABLE II

| | Example | Example | Example | Comparative | Comparative | Comparative |
|---|---|---|---|---|---|---|
| | H-1 | H-2 | H-3 | Example H-4 | Example H-5 | Example H-6 |
| Cathode | Sodium titanium oxide | | | Sodium titanium oxide | | |
| Average particle size | 10 | 5 | 10 | 30 | 10 | 10 |
| d50 [μm] | | | | | | |
| Maximum particle | 30 | 15 | 30 | 80 | 30 | 30 |
| size dmax [μm] | | | | | | |
| Water content [ppm] | <100 | <100 | <100 | <100 | about 1000 | 7.2% |
| Anode | Metallic sodium | | | Metallic sodium | | |
| Electrolyte | NaFSA- | NaFSA- | P13FSA- | NaFSA- | NaFSA- | NaFSA- |
| | KFSA | KFSA | NaFSA | KFSA | KFSA | KFSA |
| Molar ratio | 56/44 | 56/44 | 90/10 | 56/44 | 56/44 | 56/44 |

### —Evaluation of Battery—

While the half cells 1 to 6 produced in Examples H-1 to H-3 and Comparative Examples H-4 to H-6 were heated at 90° C., the battery performance was evaluated.

The half cells were subjected to a charge-discharge test at a final charging voltage of 50 mV (with reference to metallic sodium), a final discharging voltage of 1.6 V (with reference to metallic sodium), and an electric current density of 5 mA/g (sodium titanium oxide).

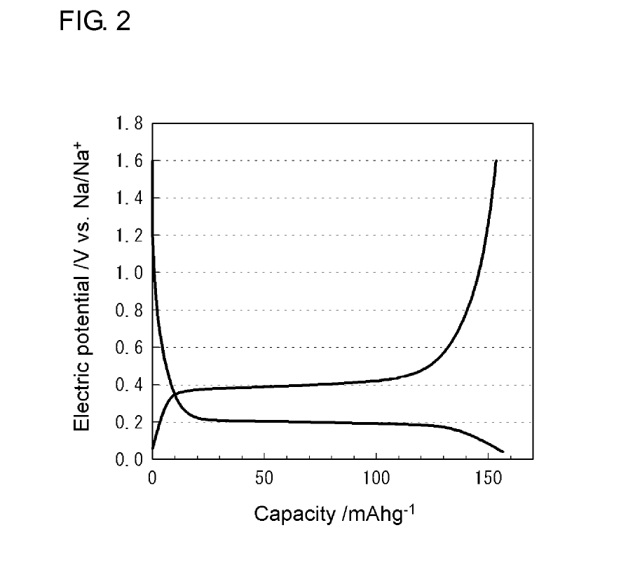

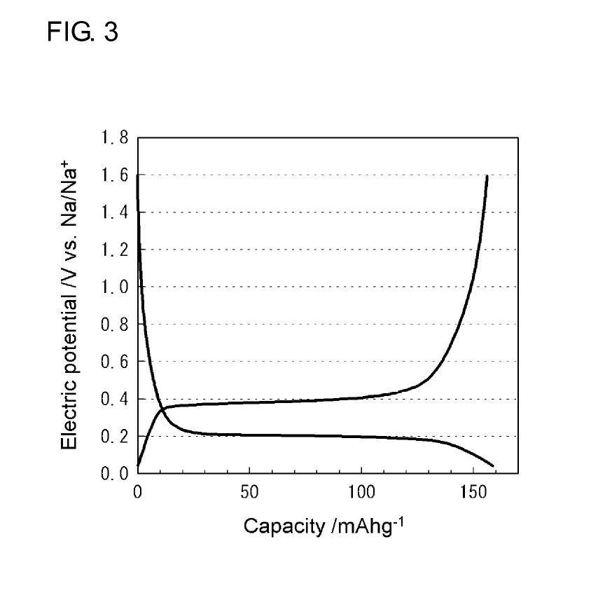

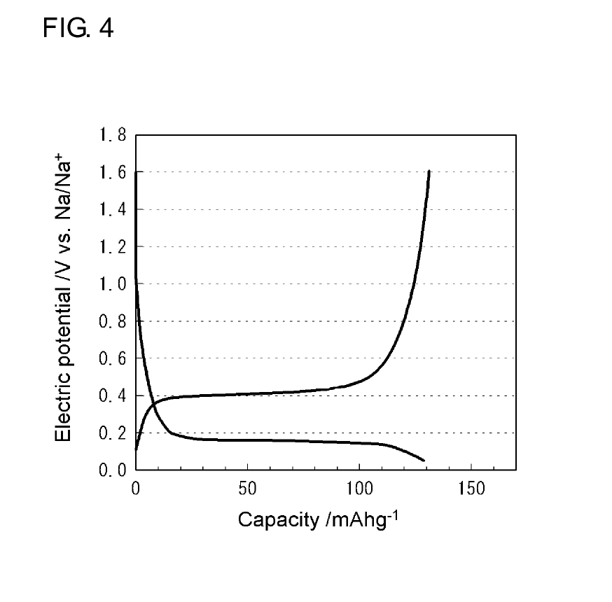

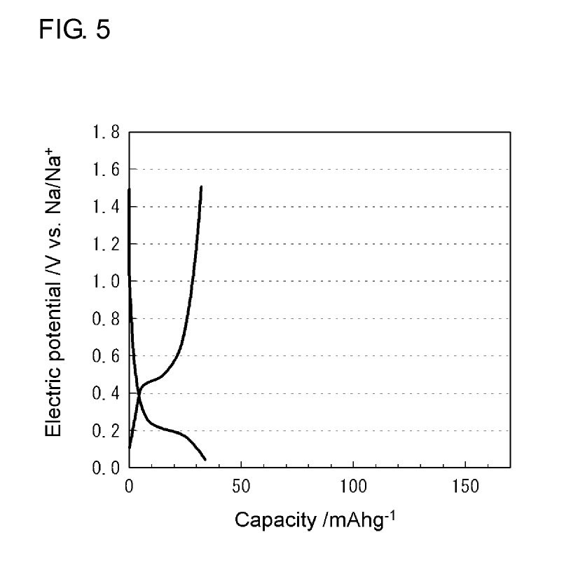

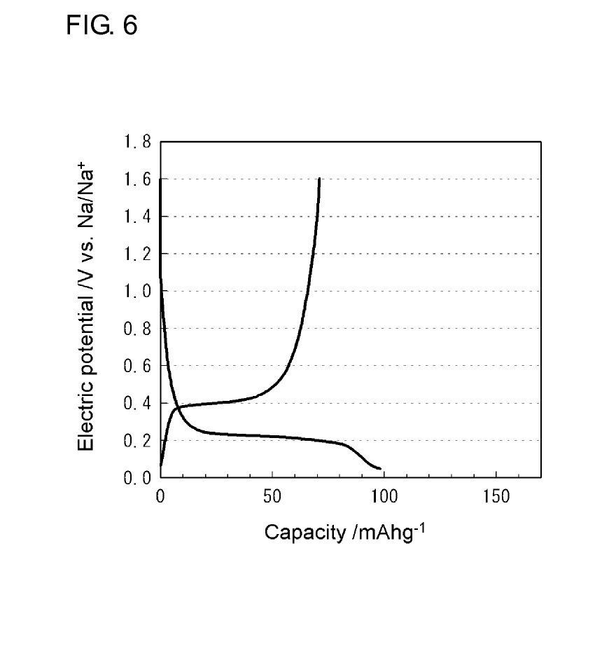

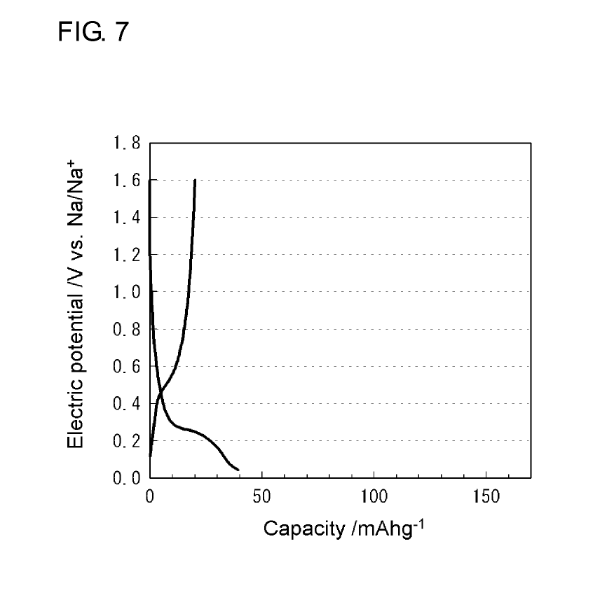

Table III shows the summary of the results for the half cells. FIGS. 2 to 7 show the specific charge-discharge properties. In these half cells, the upward-sloping curves show the discharging properties, and the downward-sloping curves show the charging properties.

TABLE III

| | Discharge capacity | | |
|---|---|---|---|
| | [mAh/g] | | Discharge capacity |
| | Initial (second) | 50th | retention rate after |
| | cycle | cycle | 50 cycles [%] |
| Example H-1 | 153 | 150 | 98 |
| Example H-2 | 155 | 152 | 98 |
| Example H-3 | 132 | 129 | 98 |
| Comparative example H-4 | 32 | 29 | 90 |
| Comparative example H-5 | 71 | 11 | 15 |
| Comparative example H-6 | 20 | — | 0 |

Table III and FIGS. 2 to 7 show that the sodium titanium oxide electrodes according to Examples H-1 to H-3 had a high initial discharge capacity and maintained a high discharge capacity over multiple charge-discharge cycles.

In contrast, the sodium titanium oxide electrodes according to Comparative Examples H-4 to H-6 had an unoptimized sodium titanium oxide particle size or a high water content. Most of these electrodes had a low initial discharge capacity, and even though having a relatively high initial discharge capacity had a low discharge capacity retention rate over multiple charge-discharge cycles and poor cycle life characteristics.

The sodium titanium oxide electrodes according to Examples H-1 to H-3 shown in FIGS. 2 to 4 used as anodes for sodium batteries have a high electric potential and capacity.

The results show that the sodium batteries according to the present invention had satisfactory cycle properties and improved life. Thus, a high-capacity sodium battery having satisfactory cycle properties can be provided.

Although the present invention has been described with reference to the embodiments, the present invention is not limited to the embodiments. Various modifications may be made in the embodiments within the scope and equivalents of the appended claims.

1. An anode active material for a sodium battery, comprising sodium titanium oxide.

2. The anode active material according to claim 1, wherein the sodium titanium oxide has the following composition formula (1) or (2).
a. Na_{2+X}Ti₃O₇ (0≦X≦0.9) Composition formula (1)
b. Na_{4+X}Ti₅O₁₂ (0≦X≦1.0) Composition formula (2)

3. The anode active material according to claim 1, wherein the sodium titanium oxide has the following composition formula (1′) or (2′).
a. Na_{2+X}Ti₃O₇ (0≦X≦2.0) Composition formula (1′)
b. Na_{4+X}Ti₅O₁₂ (0≦X≦2.0) Composition formula (2′)

4. The anode active material according to claim 1, wherein the sodium titanium oxide has an average particle size d₅₀ of 10 μm or less and a maximum particle size dₘₐₓ of 30 μm or less.

5. An anode for a sodium battery, comprising the anode active material according to claim 1.

6. The anode for a sodium battery according to claim 5, wherein the anode has a water content of less than 100 ppm.

7. A sodium battery, comprising: a cathode; an anode; a separator disposed between the cathode and the anode; and an electrolyte containing sodium, the anode being the anode according to claim 5.

8. The sodium battery according to claim 7, wherein the electrolyte is a molten salt containing sodium.

9. The sodium battery according to claim 7, wherein the electrolyte contains sodium bis(fluorosulfonyl)amide and potassium bis(fluorosulfonyl)amide.

10. The sodium battery according to claim 7, wherein the electrolyte contains a sodium cation, an organic cation, and a sulfonyl amide anion selected from bis(fluorosulfonyl)amide and bis(trifluoromethylsulfonyl)amide.

11. The sodium battery according to claim 10, wherein the organic cation is an N-methyl-N-propylpyrrolidinium cation.

12. The sodium batteries according to claim 7, wherein a cathode active material is NaCrO₂.
